(19) United States
(12) Patent Application Publication
(10) Pub. No.: US 2011/0033634 A1
(43) Pub. Date: Feb. 10, 2011

(54) PRODUCTION METHOD OF OPTICAL ELEMENT AND OPTICAL ELEMENT

(76) Inventor: Jinichi KASUYA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/846,340

(22) Filed: Jul. 29, 2010

(30) Foreign Application Priority Data
Aug. 7, 2009 (JP) JP2009-183965

(51) Int. Cl. B05D 5/06; H05H 1/00

(52) U.S. Cl. 427/539; 427/167

(57) ABSTRACT

A production method of an optical element, which is utilized in a pickup apparatus using a light source emitting light having wavelength of 380 nm to 420 nm and has a functional layer such as an anti-reflection film 60 formed on a molded portion 50 comprising a resin having an alicyclic structure, comprising steps of forming a first SiO layer 62 in the molded portion 50 by a vapor deposition process using SiO as an evaporation source and introducing O₂ gas under a predetermined pressure, forming a second SiO layer 64 on the first SiO layer by a vapor deposition process using SiO as an evaporation source and introducing O₂ gas under a pressure lower than the pressure used in forming the first SiO layer 62, and oxidizing the first SiO layer 62 and the second SiO layer 64.

### CROSS REFERENCE TO RELATED APPLICATION

This application is based on Japanese Patent Application No. 2009-183965 filed on Aug. 7, 2009 with Japan Patent Office, the entire content of which is hereby incorporated by reference.

### TECHNICAL FIELD

The present invention relates to a production method of an optical element and an optical element.

### SUMMARY OF THE INVENTION

Recently, with regard to an optical apparatus such as an optical pickup apparatus, developed is an optical apparatus corresponding to Blu-Ray Disc (hereinafter refer to as “BD”) which uses laser source emitting light having a wavelength of 380 nm to 420 nm so as to achieve higher recording density and higher data capacity than conventional CD which uses light source emitting light having a wavelength of around 780 nm or DVD which uses light source emitting light having a wavelength of around 650 nm.

On the other hand, as to an optical element used in the optical apparatus such as an objective lens or a collimator lens, desired is to produce more easily and in lower cost by using resin than using glass which cost more. In the case of a production by using resin, an anti-reflection film is often formed so as to ensure high light transmittance.

However, when an anti-reflection film is formed onto a resin made optical element, a problem is there in which peel or crack tends to occur, because this film (mainly comprises metal oxide film) is generally an inorganic material and a difference of linear coefficient of expansion between a resin used as a substrate become larger than that of a glass. Especially, sufficient adhesion cannot be obtained when SiO₂ layer which is generally utilized as an anti-oxidation film or a hard coating layer is provided as the first layer. However, in terms of necessary optical properties, to restrict a usable material is not desirable, and a solution is required. Further, as a laser light with a wavelength of 380 to 420 nm is utilized as a light source, a deterioration of resin substrate itself occurs due to energy of laser light itself, high optical accuracy is required by necessity due to be high density of recording medium and also a change of optical property due to moisture absorption of resin becomes a problem.

For above problem, Patent Document 1 discloses a technology in which heat resistance of film (resistance to heat which shows property to inhibit a generation of crack) is improved as well as improving adhesion of film in terms of forming two SiO layers onto an acrylic resin substrate and having total thickness of two layers relatively thicker as 400 nm (paragraph 0048-0050), further discloses a technology in which a specific layer in the film is ion implanted to be densified resulting in improving an anti-reflection property (paragraph 0053, 0060, and 0092).

Patent Document 1: Japanese Patent Publication Open to Public Inspection (hereinafter refers to as JP-A) No. 2004-157497.

As investigating a technology of Patent Document 1, a deterioration of resin itself due to energy of laser light or a change of optical property due to moisture absorption of resin becomes a problem at first. These problems can be improved to some extent by using a resin having an alicyclic structure with low moisture absorption. Further, by using SiO layer described in Patent Document 1, an adhesion of layer, heat resistance and anti-reflection property can be improved to some extent, comparing to the conventional case of coating SiO₂.

However, even when an optical element provided these films thereon is utilized as an optical element for high density light pickup apparatus using Blu laser light of short wavelength, it was found that not negligible change of an optical property occurs by continuous irradiating laser light for long period. Further, by applying the technology of Patent Document 1 for a long period, a property of an anti-reflection film provided on an optical element itself is changed, resulting in insufficient stability after installing in a light pickup apparatus.

In view of foregoing, a problem of changing of optical property due to radiation of blue laser light for a long term is realized by the following causes: SiO layer provided on the surface of the resin has absorption for blue laser light. SiO layer absorbs laser light energy by radiating for a long period and generates heat. This heat raises a change such as deformation, transubstantiation or cloud at a surface boundary of SiO layer and resin substrate, resulting in a problem in a light pickup apparatus for high density recording in which a precise optical property is particularly required. On the other hand, as a cause for instability of anti-reflection property after installing an optical element into a light pickup apparatus, it is found that SiO layer itself is unstable and absorbs oxygen over time, resulting in a change of optical property.

Therefore, an aspect of the present invention is to provide a production method of an optical element and an optical element in which the light resistance is improved as well as holding the adhesive property of a functional layer such as an anti-reflection film to a resin molded portion, the heat resistance and the light property.

One embodiment of the present invention is a production method of an optical element, which is utilized in a pickup apparatus using a light source emitting light having a wavelength of 380 nm to 420 nm and has a functional layer formed on a molded portion comprising a resin having an alicyclic structure. The production method comprises steps of forming a first SiO layer on the molded portion by a vapor deposition process using SiO as an evaporation source and introducing O₂ gas under a predetermined pressure, forming a second SiO layer on the first SiO layer by a vapor deposition process using SiO as an evaporation source and introducing O₂ gas under a pressure lower than the pressure used in forming the first SiO layer, and oxidizing the first SiO layer and the second SiO layer.

According to the other embodiment of the present invention, it has become possible to provide an optical element characterized by above production method.

As a result of such diligent investigations by the inventors of the present invention, it is found that the adhesive property between a resin and coating on its surface largely contributes to an adhesion property of coat forming step. Namely, when an adhesion property is improved by forming SiO layer onto a resin having an alicyclic structure, it is found remarkable result in which adhesion property can be maintained even after oxidizing SiO layer to SiO2 layer after layer forming step.

Herein, “SiO layer” according to the present invention means a layer represented by SiOₓ (x<2) formed by using SiO as an evaporation source and x can be controlled by an inlet amount of oxygen gas in a vapor deposition as appropriate.

As a result of further investigations, it is found that peel or crack of film may occur, when SiO layer is formed so as to improve the adhesion property, but is formed by only one layer under the same condition even by controlling a pressure of oxygen gas. Thus, the adhesive property of a functional layer to a resin and the suppression of the peel of film and generation of crack cannot be achieved at one time. For example, in the case of using SiO as a vapor deposition source and increasing an inlet amount of oxygen gas, an adhesion property can be improved but a crack of coat by heat resistance test under high temperature more than 80° C. cannot be solved. On the contrary, in the case of decreasing an inlet amount of oxygen gas, a problem of crack decreases but an enough adhesion property cannot be obtained.

On the other hand, it is found that these problems can be overcome by changing a pressure of oxygen gas at SiO layer forming step to have two or more layer structure.

Therefore, according to the present invention, the adhesion property can be maintained, the absorption of laser light by SiO layer at laser radiation can be suppressed, further the change of optical property caused by oxidation of SiO to SiO₂ over time after installing in the light pickup apparatus can be suppressed by the method in which two SiO layers onto a resin molded portion are formed and then followed by oxidizing these SiO layers.

In view of foregoing, the light resistance can be improved as well as maintaining the adhesive property of a functional layer to a resin molded portion, the heat resistance and the light property.

### BRIEF DESCRIPTION OF THE DRAWING

FIG. 1 is a drawing showing a schematic structure of an optical pickup apparatus which is used in one of the preferred embodiments of the present invention.

FIG. 2 is a cross-sectional view showing a schematic structure of an anti-reflection film which is used in one of the preferred embodiments of the present invention.

### DESCRIPTION OF THE ALPHANUMERIC DESIGNATIONS

30 optical pickup apparatus
32 semiconductor laser oscillator
33 collimator
34 beam splitter
35 ¼ wave length plate
36 aperture stop
37 objective lens
37a, 37b surface
38 sensor lens group
39 sensor
40 two dimensional actuator
50 resin molded portion
52 surface
60 anti-reflection film
62 the first layer
64 the second layer
66 the third layer
68 the fourth layer
D optical disk
D₁ protective substrate
D₂ information recording side

### DESCRIPTION OF THE PREFERRED EMBODIMENTS

The preferred embodiments of the present invention will be described with reference to a figure.

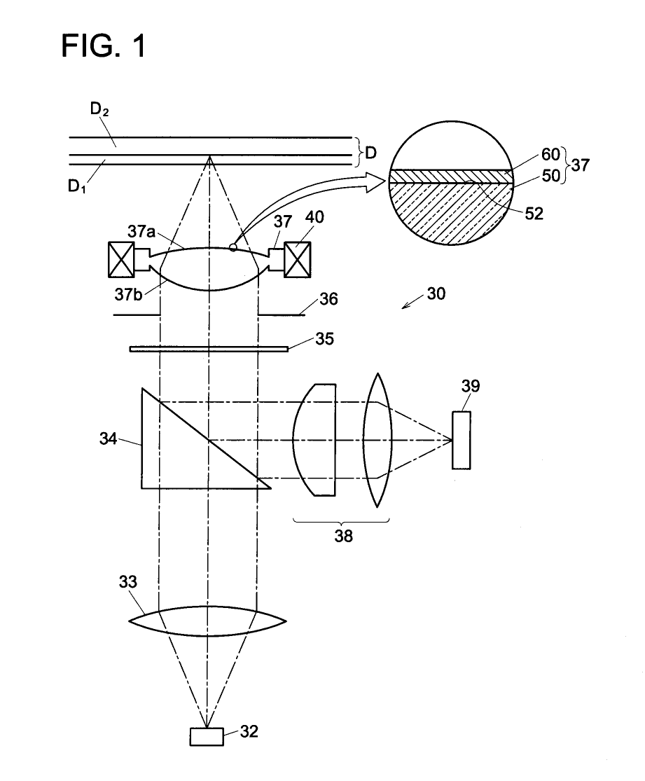

As is shown in FIG. 1, an optical pickup apparatus 30 of an example of an optical apparatus is provided with a semiconductor laser oscillator 32 as a light source. The semiconductor laser oscillator 32 emits a blue laser (a blue violet laser) of a specific wavelength of from 380 to 420 nm, for example, 405 nm for a BD (Blu-ray Disc).

A collimator 33, a beam splitter 34, a ¼ wave length plate 35, an aperture stop 36 and an objective lens 37 are arranged in sequence on the optical axis of a blue laser light emitted from the semiconductor laser oscillator 32 at a direction away from the semiconductor laser oscillator 32.

A sensor lens group 38 including two lenses, and a sensor 39 are arranged in sequence in a direction orthogonal to the blue laser optical axis at a position closed to the beam splitter 34.

The objective lens 37 is arranged at a position opposing to a high density optical disc D (an optical disc for BD), and a blue laser light emitted from the semiconductor laser oscillator 32 is condensed on a surface of the optical disk D. The objective lens 37 has a two dimensional actuator 40, and the objective lens 37 moves freely on the optical axis according to action of the two dimensional actuator 40.

As is shown in the magnified view in FIG. 1, the objective lens 37 is mainly composed of a molded portion 50, and an anti-reflection film 60 is formed on a surface 52 of the molded portion 50. According to the present embodiment, the objective lens 37 is composed of a molded portion 50 and an anti-reflection film 60, and the anti-reflection film 60 is formed on a surface 37a of the objective lens 37. The anti-reflection film 60 may be formed on the opposite surface (surface 37b) as well as the surface 37a of the objective lens 37.

The molded portion 50 is preferably composed of a polymer having an alicyclic structure in view of a light resistance for blue laser light. Preferable examples of a resin composed of polymer having an alicyclic structure are, for example, Resin 1 or 2 below. Specifically preferred resin is Resin 1, in view of enhancing an adhesion to the anti-reflection film 60.

Specifically cited examples of resins are: ZEONEX (produced by ZEON Corp.), APEL (produced by Mitsui Chemical, Inc.), ARTON (produced by JSR Corp.) and TOPAS (produced by TOPAS ADVANCED POLYMERS Gmbh).

[Resin 1]

Resin material 1 preferably contains repeating unit (a) provided with an alicyclic structure represented by Formula (1), and chain structure repeating unit (b) represented by Formulae (2) and/or (3), in the whole repeating unit of a polymer having a weight average molecular weight(Mw) of 1,000 to 1,000,000, so as to make the total content of not less than 90 mass %; and preferably further contains a alicyclic hydrocarbon type copolymer, in which the content of repeating unit (b) is not less than 1 mass % and less than 10 mass % and the chain of repeating unit (a) satisfies following Formula (Z).

A≦0.3×B Formula (Z)

wherein, A=(a weight average molecular weight of a repeating unit chain provided with an alicyclic structure), and B=(a weight average molecular weight of a repeating unit provided with an alicyclic structure (Mw))×(a number of repeating units provided with an alicyclic structure/a total number of a repealing units composing an alicyclic hydrocarbon type copolymer).

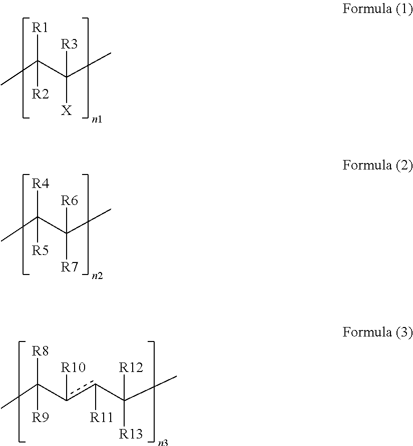

R1-R13 in Formulae (1), (2) and (3) each independently represent such as a hydrogen atom, a chain hydrocarbon group, a halogen atom, an alkoxy group, a hydroxyl group, an ether group, an ester group, a cyano group, an amide group, an imide group, a silyl group and a chain hydrocarbon group substituted by a polar group (a halogen atom, an alkoxy group, a hydroxyl group, an ether group, an ester group, a cyano group, an amide group, an imide group or a silyl group). Among them, preferable is the case of a hydrogen atom or a chain hydrocarbon group having a carbon number of 1-6, because of excellent heat resistance and low water absorbability. Halogen atoms include a fluorine atom, a chlorine atom, a bromine atom and an iodine atom. Chain hydrocarbon groups substituted by a polar group include, for example, alkyl halogenide groups having a carbon number of 1-20, preferably 1-10 and more preferably 1-6. Chain hydrocarbon groups include, for example, alkyl groups having a carbon number of 1-20, preferably 1-10 and more preferably 1-6; and alkenyl groups having a carbon number of 2-20, preferably 2-10 and more preferably 2-6.

X in formula (1) represents an alicyclic hydrocarbon group, the carbon number constituting which is generally 4-20, preferably 4-10 and more preferably 5-7. By setting the carbon number to constitute an alicyclic structure in this range, it is possible to decrease birefringence. Further, alicyclic structure is not limited to a monocyclic structure and may be a polycyclic structure such as a norbornane ring and a dicyclohexane ring.

Alicyclic hydrocarbon groups may be provided with a carbon-carbon unsaturated bond, however, the content is not more than 10%, preferably not more than 5% and more preferably not more than 3%, of the total carbon-carbon bonds. By setting the content of a carbon-carbon unsaturated bond of alicyclic hydrocarbon groups in this range, transparency and heat resistance are improved. Further, carbon atoms constituting an alicyclic hydrocarbon group may be bonded with chain hydrocarbon substituted by a hydrogen atom, a hydrocarbon group, a halogen atom, an alkoxy group, a hydroxyl group, an ether group, an ester group, a cyano group, an amide group, an imide group, a silyl group and a chain hydrocarbon group substituted by a polar group (a halogen atom, an alkoxy group, a hydroxyl group, an ether group, an ester group, a cyano group, an amide group, an imide group or a silyl group), and among them a hydrogen atom or a chain hydrocarbon group having a carbon number of 1-6 is preferred with respect to heat resistance and low water absorbability.

Further, [symbol] in Formula (3) represents a carbon-carbon saturated or unsaturated bond in the main chain, and in the case of transparency and heat resistance are strongly required, the content of the unsaturated bond is generally not more than 10%, preferably not more than 5% and more preferably not more than 3% of the total carbon-carbon bonds constituting the main chain.

Among repeating units represented by Formula (1), a repeating unit represented by following Formula (4) is superior with respect to heat resistance and low water absorbability.

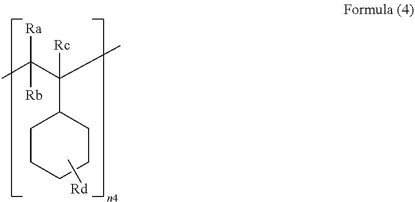

Among repeating units represented by Formula (2), a repeating unit represented by following Formula (5) is superior with respect to heat resistance and low water absorbability.

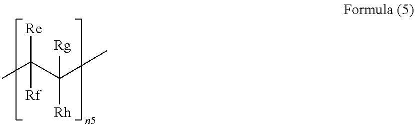

Among repeating units represented by Formula (3), a repeating unit represented by following

Formula (6) is superior with respect to heat resistance and low water absorbability.

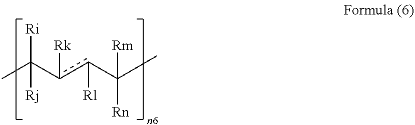

In Formulae (4), (5) and (6), Ra, Rb, Rc, Rd, Re, Rf, Rg, Rh, Ri, Rj, Rk, Rl, Rm and Rn each independently represent a hydrogen atom or a lower chain hydrocarbon group and a hydrogen atom or a lower alkyl group having a carbon number of 1-6 is superior with respect to heat resistance and low water absorbability.

Among chain structure repeating units represented by Formulae (2) and (3), a chain structure repeating unit represented by Formula (3) is more superior in strength characteristics of the obtained hydrocarbon type copolymer.

In the present invention, the total content of repeating unit (a) provided with an alicyclic structure represented by Formula (1) and chain structure repeating unit (b) represented by Formula (2) and/or Formula (3) is generally not less than 90%, preferably not less than 95% and more preferably not less than 97%, base on mass. By setting the total content in the above range, low birefringence, sufficient heat resistance and low water absorbability as well as mechanical strength are obtained while being highly balanced with each other.

The content of chain structure repeating unit (b) in an alicyclic hydrocarbon type copolymer is suitably selected depending on application purposes, however, generally in a range of not less than 1% and less than 10%, preferably not less than 1% and not more than 8% and more preferably not less than 2% and not more than 6%, based on mass. When the content of repeating unit (b) is in the above range, low birefringence, heat resistance and low water absorbability are obtained while being highly balanced with each other.

Further, the chain length of repeating unit (a) is sufficiently shorter than the molecular chain length of an alicyclic hydrocarbon type copolymer, and specifically, when A=(a weight average molecular weight of a repeating unit provided with an alicyclic structure), and B=(a weight average molecular weight of a repeating unit provided with an alicyclic structure (Mw))×(a number of repeating units provided with an alicyclic structure/the total number of repeating units constituting an alicyclic hydrocarbon type copolymer), A is in a range of not more than 30%, preferably not more than 20%, more preferably not more than 15% and most preferably not more than 10%, of B. When A is out of this range, birefringence may increase.

“Polymer having alicyclic structure” can be provided by using well-known production method.

For example, production method of an alicyclic hydrocarbon based copolymer include: (1) a method in which an aromatic vinyl compound is copolymerized with other co-polymerizable monomer followed by hydrogenating carbon-carbon unsaturated bond in a main chain and an aromatic ring, and (2) a method in which an alicyclic vinyl compound is copolymerized with other co-polymerizable monomer followed by hydrogenating as appropriate.

[Resin 2]

Resin 2 comprises a copolymer of α-olefin and a cyclic olefin represented by Formula (I) or (II)

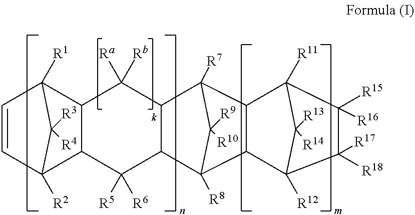

In Formula (I), n is 0 or 1, m is 0 or a positive integer, and k is 0 or 1. R¹ to R¹⁸ and R^{a} and R^{b} independently represent a hydrogen atom, a halogen atom or a hydrocarbon group.

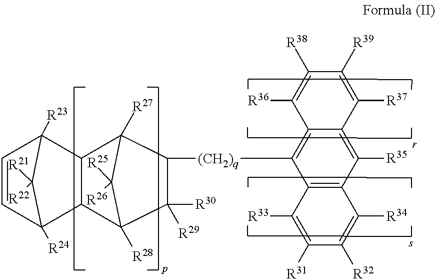

In Formula (II), p and q independently represent 0 or a positive integer and r and s independently represent 0, 1 or 2. R²¹ to R³⁹ independently represent a hydrogen atom, a halogen atom, a hydrocarbon group or an alkoxy group.

[Cyclic Olefin Represented by Formula (I) and (II)]

In Formula a (I), n is 0 or 1, m is 0 or a positive integer, and k is 0 or 1. In the case where k is 1, the ring that is shown using k has 6 member rings, while the ring has 5 member rings when k is 0.

R¹ to R¹⁸ and R^{a} and R^{b} independently represent a hydrogen atom, a halogen atom or a hydrocarbon group. The halogen atom herein represents a fluorine atom, a chlorine atom, a bromine atom or an iodine atom.

Examples of the hydrocarbon group include an alkyl group having 1-20 carbon atoms, a halogenated alkyl group having 1-20 carbon atoms, a cycloalkyl group or an aromatic hydrocarbon group having 3-15 carbon atoms. More specifically, examples of the alkyl group include a methyl group, an ethyl group, a propyl group, an isopropyl group, an amyl group, a hexyl group, an octyl group, a decyl group, a dodecyl group and an octadecyl group. These alkyl groups may be substituted by a halogen atom.

An example of the cycloalkyl group is cyclohexyl. Examples of the aromatic hydrocarbon include a phenyl group, a naphthyl group. In addition in Formula (I), R¹⁵ and R¹⁶, R¹⁷ and R¹⁸, R¹⁵ and R¹⁷, R¹⁶ and R¹⁸, R¹⁵ and R¹⁸ or R¹⁶ and R¹⁷, may each bond (with each other) and form a monocyclic or polycyclic group, and the monocyclic or polycyclic group formed in this manner may have double bonds. Specific examples of the monocyclic or polycyclic group formed herein are given below.

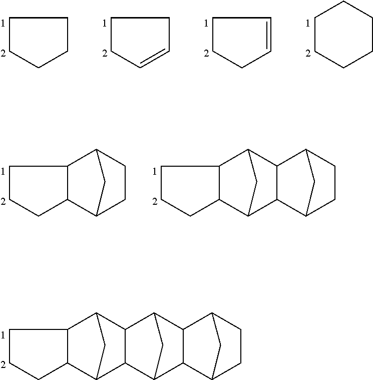

The carbon atoms that have been numbered 1 or 2 in the above example having monocyclic or polycyclic ring represent carbon atoms that bond with R¹⁵ (R¹⁶) or R¹⁷ (R¹⁸) respectively of Formula (I).

Also an alkylidene group may also be formed with R¹⁵ and R¹⁶ or R¹⁷ and R¹⁸. This type of alkylidene group has 2-20 carbon atoms and specific examples of this type of alkylidene group include an ethylidene group, a propylidene group and an isopropylidene group.

In Formula (II), p and q independently represent 0 or a positive integer and r and s independently represent 0, 1 or 2. R²¹ to R³⁹ independently represent a hydrogen atom, a halogen atom, a hydrocarbon group or an alkoxy group.

The halogen atom herein is the same as the halogen atom in Formula (I). Examples of the hydrocarbon include an alkyl group having 1 to 20 carbon atoms, a cycloalkyl group or an aromatic hydrocarbon having 3-15 carbon atoms. More specifically, examples of the alkyl group include a methyl group, an ethyl group, a propyl group, an isopropyl group, an amyl group, a hexyl group, an octyl group, a decyl group, a dodecyl group and an octadecyl group. These alkyl groups may be substituted by a halogen atom.

An example of the cycloalkyl group is a cyclohexyl group. Examples of the aromatic hydrocarbon include an aryl group and an aralkyl group, and more specifically, a phenyl group, a tolyl group, a naphthyl group, a benzyl group and a phenylethyl group.

Examples of the alkoxy group include a methoxy group, an ethoxy group and a propoxy group. The carbon atoms which bonds with R²⁹ and R³⁰, the carbon atom which bonds with R³³ and the carbon atom which bonds with R³¹ may bond together directly or via a alkylene group having 1-3 carbon atoms. In the case where the two carbon atoms are bonded together via an alkylene group, R²⁹ and R³³ or R³⁰ and R³¹ together with each other form one of alkylene groups which are the methylene group (—CH₂—), ethylene group (—CH₂CH₂—) or propylene group (—CH₂CH₂CH₂—).

R³⁵ and R³² or R³⁵ and R³⁹ may bond to each other to form a monocyclic or polycyclic aromatic ring when r=s=0,. More specifically, when r=s=0, examples of the aromatic ring which is formed from R³⁵ and R³² include the following.

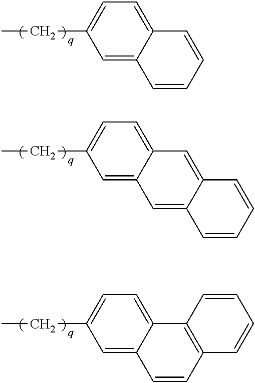

Herein q is the same as in Formula (II).

Specific examples of the cyclic olefins shown in Formula (I) and Formula (II) above include bicyclo-2-heptene derivatives (bicyclohept-2-ene derivatives), tricyclo-3-decene derivatives, tricyclo-3-undecene derivatives, tetracyclo-3-dodecene derivatives, pentacyclo-4-pentadecene derivatives, pentacyclopentadecadiene derivatives, pentacyclo-3-pentadecene derivatives, pentacyclo-3-hexadecene derivatives, pentacyclo-4-hexadecene derivatives, hexacyclo-4-heptadecene derivatives, heptacyclo-5-eicocene derivatives, heptacyclo-4-eicocene derivatives, heptacyclo-5-heneicocene derivatives, octacyclo-5-docecene, nonacyclo-5-pentacocene, nonacyclo-6-hexacocene derivatives, cyclopentadiene-acenapthtylene addition compounds, 1,4-metano-1,4,4a,9a-tetrahydrofluorene derivatives and 1,4-metano-1,4,4a,5,10,10a-hexahydroantracene derivatives.

More specific examples of the cyclic olefins represented by Formula (I) and Formula (II) above are shown below, however the present invention is not limited thereto.

<<Bicyclo[2.2.1]hept-2-ene derivatives>>
1 bicyclo[2.2.1]hept-2-ene,
2 6-methyl bicyclo[2.2.1]hept-2-ene,
3 5,6-dimethyl bicyclo[2.2.1]hept-2-ene,
4 1-methyl bicyclo[2.2.1]hept-2-ene,
5 6-ethyl bicyclo[2.2.1]hept-2-ene,
6 6-n-butyl bicyclo[2.2.1]hept-2-ene,
7 6-isobutyl bicyclo[2.2.1]hept-2-ene,
8 7-methyl bicyclo[2.2.1]hept-2-ene.

<<Tetracyclo[4.4.0.1^{2.5}.1^{7.10}]-3-dodecene derivatives>>
9 tetracyclo[4.4.0.1^{2.5}.1^{7.10}]-3-dodecene,
10 8-methyl tetracyclo[4.4.0.1^{2.5}.1^{7.10}]-3-dodecene,
11 8-ethyl tetracyclo[4.4.0.1^{2.5}.1^{7.10}]-3-dodecene,
12 8-propyl tetracyclo[4.4.0.1^{2.5}.1^{7.10}]-3-dodecene,
13 8-butyl tetracyclo[4.4.0.1^{2.5}.1^{7.10}]-3-dodecene,
14 8-isobutyl tetracyclo[4.4.0.1^{2.5}.1^{7.10}]-3-dodecene,
15 8-hexyl tetracyclo[4.4.0.1^{2.5}.1^{7.10}]-3-dodecene,
16 8-cyclohexyl tetracyclo[4.4.0.1^{2.5}.1^{7.10}]-3-dodecene,
17 8-stearyl tetracyclo[4.4.0.1^{2.5}.1^{7.10}]-3-dodecene,
18 5,10-dimethyl tetracyclo[4.4.0.1^{2.5}.1^{7.10}]-3-dodecene,
19 2,10-dimethyl tetracyclo[4.4.0.1^{2.5}.1^{7.10}]-3-dodecene,
20 8,9-dimethyl tetracyclo[4.4.0.1^{2.5}.1^{7.10}]-3-dodecene,
21 8-ethyl-9-methyl tetracyclo[4.4.0.1^{2.5}.1^{7.10}]-3-dodecene,
22 11,12-dimethyl tetracyclo[4.4.0.1^{2.5}.1^{7.10}]-3-dodecene,
23 2,7,9-trimethyl tetracyclo[4.4.0.1^{2.5}.1^{7.10}]-3-dodecene,
24 9-ethyl-2,7-dimethyl tetracyclo[4.4.0.1^{2.5}.1^{7.10}]-3-dodecene,
25 9-isobutyl-2,7-dimethyl tetracyclo[4.4.0.1^{2.5}.1^{7.10}]-3-dodecene,
26 9,11,12-trimethyl tetracyclo[4.4.0.1^{2.5}.1^{7.10}]-3-dodecene,
27 9-ethyl-11,12-dimethyl tetracyclo[4.4.0.1^{2.5}.1^{7.10}]-3-dodecene,
28 9-isobutyl-11,12-dimethyl tetracyclo[4.4.0.1^{2.5}.1^{7.10}]-3-dodecene,
29 5,8,9,10-tetramethyl tetracyclo[4.4.0.1^{2.5}.1^{7.10}]-3-dodecene,
30 8-ethylidene tetracyclo[4.4.0.1^{2.5}.1^{7.10}]-3-dodecene,
31 8-ethylidene-9-methyl tetracyclo[4.4.0.1^{2.5}.1^{7.10}]-3-dodecene,
32 8-ethylidene-9-ethyl tetracyclo[4.4.0.1^{2.5}.1^{7.10}]-3-dodecene,
33 8-ethylidene-9-isopropyl tetracyclo[4.4.0.1^{2.5}.1^{7.10}]-3-dodecene,
34 8-ethylidene-9-butyl tetracyclo[4.4.0.1^{2.5}.1^{7.10}]-3-dodecene,
35 8-n-propylidene tetracyclo[4.4.0.1^{2.5}.1^{7.10}]-3-dodecene,
36 8-n-propylidene-9-methyl tetracyclo[4.4.0.1^{2.5}.1^{7.10}]-3-dodecene,
37 8-n-propylidene-9-ethyl tetracyclo[4.4.0.1^{2.5}.1^{7.10}]-3-dodecene,
38 8-n-propylidene-9-isopropyl tetracyclo[4.4.0.1^{2.5}.1^{7.10}]-3-dodecene,
39 8-n-propylidene-9-butyl tetracyclo[4.4.0.1^{2.5}.1^{7.10}]-3-dodecene,
40 8-isopmpylidene tetracyclo[4.4.0.1^{2.5}.1^{7.10}]-3-dodecene,
41 8-isopropylidene-9-methyl tetracyclo[4.4.0.1^{2.5}.1^{7.10}]-3-dodecene,
42 8-isopropylidene-9-ethyl tetracyclo[4.4.0.1^{2.5}.1^{7.10}]-3-dodecene,
43 8-isopropylidene-9-isopropyl tetracyclo[4.4.0.1^{2.5}.1^{7.10}]-3-dodecene,
44 8-isopropylidene-9-butyl tetracyclo[4.4.0.1^{2.5}.1^{7.10}]-3-dodecene,
45 8-chloro tetracyclo[4.4.0.1^{2.5}.1^{7.10}]-3-dodecene,
46 8-bromo tetracyclo[4.4.0.1^{2.5}.1^{7.10}]-3-dodecene,
47 8-fluoro tetracyclo[4.4.0.1^{2.5}.1^{7.10}]-3-dodecene,
48 8,9 dichloro tetracyclo[4.4.0.1^{2.5}.1^{7.10}]-3-dodecene.

<<Hexacyclo[6.6.1.1^{3.6}.1^{10.13}.0^{2.7}.0^{9.14}]-4-heptadecen derivatives>>
49 hexacyclo[6.6.1.1^{3.6}.1^{10.13}.0^{2.7}.0^{9.14}]-4-heptadecen.
50 12-methyl hexacyclo[6.6.1.1^{3.6}.1^{10.13}.0^{2.7}.0^{9.14}]-4-heptadecen,
51 12-ethyl hexacyclo[6.6.1.1^{3.6}.1^{10.13}.0^{2.7}.0^{9.14}]-4-heptadecen,
52 12-isobutyl hexacyclo[6.6.1.1^{3.6}.1^{10.13}.0^{2.7}.0^{9.14}]-4-heptadecen,
53 1,6,10-trimethyl-12-isobutylhexacyclo[6.6.1.1^{3.6}.1^{10.13}.0^{2.7}.0^{9.14}]-4-heptadecen.

<<Octacycio[8.8.0.1^{2.9}.1^{4.7}.1^{11.18}.1^{13.16}.0^{3.8}.0^{12.17}]-5-dococene derivatives>>
54 octacyclo[8.8.0.1^{2.9}.1^{4.7}.1^{4.7}.1^{11.18}.1^{13.16}.0^{3.8}.0^{12.17}]-5-dococene,
55 15-methyl octacyclo[8.8.0.1^{2.9}.1^{4.7}.1^{11.18}.1^{13.16}.1^{3.8}.0^{12.17}]-5-dococene,
56 15-ethyl octacyclo[8.8.0.1^{2.9}.1^{4.7}.1^{11.18}.1^{13.16}.0^{3.8}.0^{12.17}]-5-dococene.

<<Pentacyclo[6.6.1.1^{3.6}.0^{2.7}.0^{9.14}]-4-hexadecene derivatives>>
57 pentacyclo[6.6.1.1^{3.6}.0^{2.7}.0^{9.14}]-4-hexadecene,
58 1,3-dimethyl pentacyclo[6.6.1.1^{3.6}.0^{2.7}.0^{9.14}]-4-hexadeeene,
59 1,6-dimethyl pentacyclo[6.6.1.1^{3.6}.0^{2.7}.0^{9.14}]-4-hexadecene,
60 15,16-dimethyl pentacyclo[6.6.1.1^{3.6}.0^{2.7}.0^{9.14}]-4-hexadecene.

<<Heptacyclo-5-eicocene derivatives or heptacyclo-5-heneicocene derivatives>>
61 heptacyclo[8.7.0.1^{2.9}.1^{4.7}.1^{11.17}.0^{3.8}.0^{12.16}]-5-eicocene,
62 heptacyclo[8.8.0.1^{2.9}.1^{4.7}.1^{11.18}.0^{3.8}.0^{12.17}]-5-heneicocene.

<<Tricyclo[4.3.0.1^{2.5}]-3-decene derivatives>>
63 tricyclo[4.3.0.1^{2.5}]-3-decene,
64 2-methyl tricyclo[4.3.0.1^{2.5}]-3-decene,
65 5-methyl tricyclo[4.3.0.1^{2.5}]-3-decene.

<<Tricyclo[4.4.0.1^{2.5}]-3-undecene derivatives>>
66 tricyclo[4.4.0.1^{2.5}]-3-undecene,
67 10-methyl tricyclo[4.4.0.1^{2.5}]-3-undecene.

<<Pentacyclo[6.5.1.1^{3.6}.0^{2.7}.0^{9.13}]-4-pentadecene derivatives>>
68 pentacyclo[6.5.1.1^{3.6}.0^{2.7}.0^{9.13}]-4-pentadecene,
69 1,3 dimethyl pentacyclo[6.5.1.1^{3.6}.0^{2.7}.0^{9.13}]-4-pentadecene,
70 1,6 dimethyl pentacyclo[6.5.1.1^{3.6}.0^{2.7}.0^{9.13}]-4-pentadecene,
71 14,15 dimethyl pentacyclo[6.5.1.1^{3.6}.0^{2.7}.0^{9.13}]-4-pentadecene.

<<Diene compounds>>
72 pentacyclo[6.5.1.1^{3.6}.0^{2.7}.0^{9.13}]-4,10-pentadecadiene.

<<Pentacyclo[7.4.0.1^{2.5}.1^{9.12}.0^{8.13}]-3-penrtadecene derivatives>>
73 pentacyclo[7.4.0.1^{2.5}.1^{9.12}.0^{8.13}]-3-pentadecene,
74 methyl substituted pentacyclo[7.4.0.1^{2.5}.1^{9.12}.0^{8.13}]-3-pentadecene

<<Heptacyclo[8.7.0.1^{3.6}.1^{10.17}.1^{12.15}.0^{2.7}.0^{11.16}]-4-eicocene derivatives>>
75 heptacyclo[8.7.0.1^{3.6}.1^{10.17}.1^{12.15}.0^{2.7}.0^{11.16}]-4-eicocene,
76 dimethyl substituted heptacyclo[8.7.0.1^{3.6}.1^{10.17}.1^{12.15}.0^{2.7}.0^{11.16}]-4-eicocene.

<<Nonacyclo[10.9.1.1^{4.7}.1^{13.20}.1^{15.18}.0^{3.8}.0^{2.10}.0^{12.21}.0^{14.19}]-5-pentacocene derivatices>>
77 nanocyclo[10.9.1.1^{4.7}.1^{13.20}.1^{15.18}.0^{3.8}.0^{2.10}.0^{12.21}.0^{14.19}]-5-pentacocene,
78 trimethyl substituted nonacyclo[10.9.1.1^{4.7}.1^{13.20}.1^{15.18}.0^{3.8}.0^{2.10}.0^{12.21}.0^{14.19}]-5-pentacocene.

<<Pentacyclo[8.4.0.1^{2.5}.1^{9.12}.0^{8.13}]-3-hexadecene derivatives>>
79 pentacyclo[8.4.0.1^{2.5}.1^{9.12}.0^{8.13}]-3-hexadecene,
80 11-methyl-pentacyclo[8.4.0.1^{2.5}.1^{9.12}.0^{8.13}]-3-hexadecene,
81 11-ethyl-pentacyclo[8.4.0.1^{2.5}.1^{9.12}.0^{8.13}]-3-hexadecene,
82 10,11-dimethyl-pentacyclo[8.4.0.1^{2.5}.1^{9.12}.0^{8.13}]-3-hexadecene.

<<Heptacyclo[8.8.0.1^{4.7}.1^{11.18}.1^{13.16}.0^{3.8}.0^{12.17}]-5-heneicocene derivatives>>
83 heptacyclo[8.8.0.1^{4.7}.1^{11.18}.1^{13.16}.0^{3.8}.0^{12.17}]-5-heneicocene,
84 15-methyl-heptacyclo[8.8.0.1^{4.7}.1^{11.18}.1^{13.16}.0^{3.8}.0^{12.17}]-5-heneicocene,
85 timethyl-heptacyclo[8.8.0.1^{4.7}.1^{11.18}.1^{13.16}.0^{3.8}.0^{12.17}]-5-heneicocene.

<<Nonacyclo[10.10.1.1^{5.8}.1^{14.21}.1^{16.19}.0^{2.11}.0^{4.9}.0^{13.22}.0^{15.20}]-5-hexacocene derivatives>>
86 nonacyclo[10.10.1.1^{5.8}.1^{14.21}.1^{16.19}.0^{2.11}.0^{4.9}.0^{13.22}.0^{15.20}]-5-hexacocene.

<<Other examples>>
87 5-phenyl-bicyclo[2.2.1]hept-2-ene,
88 5-methyl-5-phenyl-bicyclo[2.2.1]hept-2-ene,
89 5-benzyl-bicyclo[2.2.1]hept-2-ene,
90 5-tolyl-bicyclo[2.2.1]hept-2-ene,
91 5-(ethylphenyl)-bicyclo[2.2.1]hept-2-ene,
92 5-(isopropylphenyl)-bicyclo[2.2.1]hept-2-ene,
93 5-(biphenyl)-bicyclo[2.2.1]hept-2-ene,
94 5-(β-naphtyl)-bicyclo[2.2.1]hept-2-ene,
95 5-(α-naphtyl)-bicyclo[2.2.1]hept-2-ene,
96 5-(antracenyl)-bicyclo[2.2.1]hept-2-ene,
97 5,6-(diphenyl)-bicyclo[2.2.1]hept-2-ene,
98 cyclopentadiene-acenaphtylene addition compounds,
99 1,4-methano-1,4,4a,9a-tetrahydrofluorene,
100 1,4-methano-1,4,4a,5,10,10a-hexahydroanthracene,
101 8-phenyl-tetracyclo[4.4.0.0^{3.5}.1^{7.10}]-3-dodecene,
102 8-methyl-8-phenyl-tetracyclo[4.4.0.0^{3.5}.1^{7.10}]-3-dodecene,
103 8-benzyl-tetracyclo[4.4.0.0^{3.5}.1^{7.10}]-3-dodecene,
104 8-tolyl-tetracyclo[4.4.0.0^{3.5}.1^{7.10}]-3-dodecene,
105 8-(ethylphenyl)-tetracyclo[4.4.0.0^{3.5}.1^{7.10}]-3-dodecene,
106 8-(isopropylphenyl)-tetracyclo[4.4.0.0^{3.5}.1^{7.10}]-3-dodecene,
107 8,9-diphenyl-tetracyclo[4.4.0.0^{2.5}.1^{7.10}]-3-dodecene,
108 8-(biphenyl)-tetracyclo[4.4.0.0^{2.5}.1^{7.10}]-3-dodecene,
109 8-(β-naphtyl)-tetracyclo[4.4.0.0^{2.5}.1^{7.10}]-3-dodecene,
110 8-(α-naphtyl)-tetracyclo[4.4.0.0^{2.5}.1^{7.10}]-3-dodecene,
111 8-(antracenyl)-tetracyclo[4.4.0.0^{2.5}.1^{7.10}]-3-dodecene,
112 addition compounds in which cyclopentadiene is further added to (cyclopentadiene-acenaphtylene addition compounds),
113 11,12-benzo-pentacyclo[6.5.1.1^{3.6}.0^{2.70}.0^{9.13}]-4-pentadecene,
114 11,12-benzo-pentacyclo[6.5.1.1^{3.6}.0^{2.7}.0^{9.13}]-4-hexadecene,
115 11-phenyl-hexacyclo[6.6.1.1^{3.6}.1^{10.13}.0^{2.7}.0^{9.14}]-4-pentadecene,
116 14,15-benzo-heptacyclo[8.7.0.1^{2.9}.1^{4.7}.1^{11.17}.0^{3.8}.0^{12.16}]-5-eicocene.

[α-Olefin]

In addition, examples of the α-olefin that forms the copolymer include straight chain α-olefins such as ethylene, propylene, 1-butene, 1-pentene, 1-hexene, 1-octene, 1-decene, 1-dodecene, 1-tetradecene, 1-hexadecene, 1-octadecene and 1-eicocene; branched chain α-olefins such as 4-methyl-1-pentene, 3-methyl-1-pentene and 3-methyl-1-butene. α-olefins having 2-20 carbon atoms are preferable. The straight chain and branched chain olefins may be substituted with a substitution group, and may be used singly or in combinations of two or more.

The various substitution groups are not particularly limited and typical examples include alkyl, aryl, anilino, acylamino, sulfonamide, alkylthio, arylthio, alkenyl, cycloalkyl, cycloalkenyl, alkinyl, heterocycle, alkoxy, aryloxy, heterocyclic oxy, siloxy, amino, alkylamino, imido, ureido, sulfamoylamino, alkoxycarbonylamino aryloxycarbonylamino, alkoxycarbonyl, aryloxycarbonyl, heterocyclicthio, thioureido, hydroxyl and mercapto groups, as well as spiro compound residues, bridged hydrocarbon compound residues, sulfonyl, sulfinyl, sulfonyloxy, sulfamoyl, phosphoryl, carbamoyl, acyl, acyloxy, oxycarbonyl, carboxyl, cyano, nitro, halogen substituted alkoxy, halogen substituted aryloxy, pyrrolyl, tetrazolyl groups and halogen atoms and the like.

The alkyl group preferably has 1-32 carbon atoms, and may be straight chain or branched. The aryl group is preferably a phenyl group.

Examples of the acylamino group include an alkylcarbonylamino group and an arylcarbonylamino group. Examples of the sulfonamide group include an alkylsulfonylamino group, an arylsulfonylamino group. Examples of the alkyl component and aryl component in the alkylthio group and the arylthio group include the alkyl groups and aryl groups above.

The alkenyl group preferably has 2-23 carbon atoms, and the cycloalkyl group preferably has 3-12 carbon atoms and a group with 5-7 carbon atoms is particularly preferable and the alkenyl group may be a straight or branched chain. The cycloalkenyl group preferably has 3-12 carbon atoms and a group with 5-7 carbon atoms is particularly preferable.

Examples of the ureido group include an alkyl ureido group, an aryl ureido group. Examples of the sulfamoyl amino group include an alkyl sulfamoyl amino group and an aryl sulfamoyl amino group. The heterocyclic group preferably has 5-7 members and specific examples include 2-furyl, 2-thienyl, 2-pyrimidinyl, 2-benzothiazolyl and the like. The saturated heterocyclic ring preferably has 5-7 members, and specific examples include tetrahydropyranyl, tetrahydrothiopyranyl and the like. The heterocyclic oxy group preferably has a heterocyclic ring having 5-7 members and specific examples include 3,4,5,6-tetrahydropyranyl-2-oxy, 1-phenyltetrazole-5-oxy and the like. The heterocyclic thio group preferably has 5-7 members and examples include 2-pyridyl thio, 2-benzothiazorylthio and 2,4-diphenoxy-1,3,5-triazole-6-thio. Examples of the siloxy group include trimethylsiloxy, triethylsiloxy and dimethylbutylsiloxy. Examples of the imide group include imide succinate, 3-heptadecyl imide succinate, phthalimide, glutarimide and the like. Examples of the spiro compound residue include spiro[3.3]heptane-1-yl and the like. Examples of the bridged hydrocarbon compound residue include bicyclo[2.2.1]heptan-1-yl, tricyclo[3.3.1.13.7]decan-1-yl, and 7,7-dimethyl-bicyclo[2.2.1]heptan-1-yl and the like.

Examples of the sulfonyl group include an alkylsulfonyl group, an arylsulfonyl group, a halogen substituted alkyl sulfonyl group, a halogen substituted aryl sulfonyl group and the like. Examples of the sulfinyl group include an alkyl sulfinyl group, an aryl sufinyl group and the like. Examples of the sulfonyloxy group include an alkyl sulfonyl oxy group, an aryl sulfonyl oxy group and the like. Examples of the sulfamoyl group include an N,N-dialkyl sulfamoyl group, an N,N-diaryl sulfamoyl group, an N-alkyl-N-aryl sulfamoyl group and the like. Examples of the phosphoryl group include an alkoxy phosphoryl group, an aryloxy phosphoryl group, an alkyl phosphoryl group, an aryl phosphoryl group and the like. Examples of the carbamoyl group include an N,N-dialkyl carbamoyl group, N,N-diaryl carbamoyl group, an N-alkyl-N-aryl carbamoyl group and the like. Examples of the acyl group include an alkyl carbonyl group, an aryl carbonyl group and the like. Examples of the acyloxy group include an alkylcarbonyloxy group and the like. Examples of the oxycarbonyl group include an alkoxy carbonyl group, an aryloxy carbonyl group and the like. Examples of the halogen substituted alkoxy group include an α-halogen substituted alkoxy group. Examples of the halogen substituted aryloxy group include a tetrafluoroaryloxy group, a pentafluoraryloxy group and the like. Examples of the pyrrolyl group include 1-pyrrolyl and the like. Examples of the tetrazolyl group include 1-tetrazolyl and the like.

Aside from the above substitution groups, groups such as trifluoromethyl, heptafluoro-i-propyl, nonylfluoro-t-butyl, and a tetrafluoroaryl group, a pentafluoroaryl group and the like may be preferably used. In addition, the substitution groups may be substituted by other substitution groups.

A content of non-cyclic monomer in the copolymer is preferably 20% or more by mass, more preferably 25-90% by mass, most preferably 30-85% by mass, in view of a molding property.

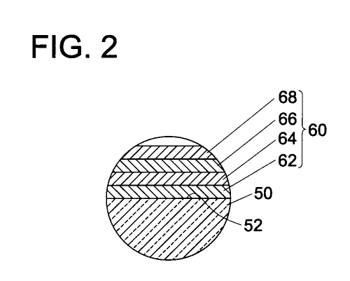

The anti-reflection film 60 is an example of a function layer, and has a multi-layer structure which laminates a plurality of layers. More specifically, as shown in FIG. 2, the first layer 62 is directly formed on a surface 52 of a resin molding portion, and provided thereon the second layer 64, the third layer 66 and the fourth layer 68 in these order.

The first layer 62 is a SiO layer having a reflective index of 1.47-1.53 and oxidation treated thereof. A thickness of the first layer 62 is 10-50 nm.

The second layer 64 is a SiO layer having a refractive index of 1.53-1.83 and oxidation treated thereof. A thickness of the second layer 62 is 190-5000 nm.

Total layer thickness which is a sum of a thickness of the first layer 62 and a thickness of the second layer 64 is preferably 400 nm or more. In the case that the total thickness is 400 nm or more, a cloud or a deformation of a resin mold portion 50 can be suppressed, resulting in improving a light fastness of an objective lens 37, even when the Blue laser with the wavelength of 405 nm is continued to irradiate thereto.

The third layer 66 is composed of a high refractive material having a refractive index of larger than 1.61 and preferably composed of any one of Ta₂O₅, a mixture of Ta₂O₅ and TiO₂, ZrO₂, and a mixture of ZrO₂ and TiO₂.

The third layer 66 may be composed of SC₂O₃, LaF₂, Y₂O₃, HfO₃, TaO, TiO₂, Nb₂O₃SiN or a mixture thereof.

The fourth layer 68 is composed of a low refractive material having a refractive index of less than 1.61 and preferably composed of AlF, Al₂O₃, SiO₂ and MgF₂.

Herein, according to the present embodiment, on the third layer 66 and the fourth layer 68, a high refractive material layer and a low refractive material layer same as the third layer 66 and the fourth layer 68 may be alternately laminated to be a multi-layer structure of 6 layers or more at the anti-reflection film. On the other hand, the third layer 66, the fourth layer 68 and after the fifth layer may not be required.

Then, the production method of the objective lens 37 will be described.

At first, the above-described thermoplastic resin is inject-molded in a mold under the predetermined conditions to from a molded portion 50 having a specific structure.

Then, an anti-reflection film 60 is formed on one surface 52 of the molded portion 50 with a method such as vapor deposition method using electron beam. More specifically, by using SiO as an evaporation source, an oxygen gas (O₂) at a predetermined pressure (1.5×10⁻²−2.5×10⁻² Pa) is introduced in a vapor deposition apparatus, thereby the first layer 62 (SiO layer) having a refractive index of 1.47-1.53 and a layer thickness of 10-50 nm is formed. In this case, a vapor deposition via a resistance heating method may be employed. This method results in improving an adhesion resistance of an anti-reflection film 60 (the first layer 62) to a resin molded portion 50 compared to that of a vapor deposition via electron beam.

Successively, by using SiO as an evaporation source, an oxygen gas at a lower pressure (5.0×10⁻³−1.5×10⁻² Pa) than that of forming the first layer 62 is introduced in a vapor deposition apparatus, thereby the second layer 64 (SiO layer) having a refractive index of 1.53-1.83 and a layer thickness of 190-5000 nm is formed.

Successively, an oxidation treatment is applied to an optical element (a molded portion 50) on which the first layer 62 and the second layer 64 were provided, resulting in a refractive index of the first layer 62 and the second layer 64 being 1.47-1.53.

“Oxidation treatment of the first layer 62 and the second layer 64” includes not only a case in which both of the first layer 62 and the second layer 64 are completely oxidized to be SiO₂ but also a case in which a part of each layer is oxidized.

In the embodiment of the present invention, described is a case of two layer structure in which after forming SiO layer by introducing much inlet O₂ gas, other layer is formed by reducing inlet O₂ gas. However further one or a plurality of SiO layers may be formed thereon.

Moreover, one or a plurality of an anti-reflection film may be formed on SiO layer in accordance with necessary anti-reflection properties. In that case, an oxidation treatment may be applied after or before forming an anti-reflection film on SiO layer. In view of stability of layer, an oxidation treatment is preferably applied after forming all anti-reflection film.

As a method of an oxidation treatment, listed is a method in which the optical element on which the first layer 62 and the second layer 64 (a molded portion 50) were provided are held (let stand) for 10 hours to around 7 days under an ambience of 90° C. or lower and 90% R.H. Standing time is preferably 24 hours (1 day) to around 7 days.

As other method of an oxidation treatment, listed is a method of an ion implantation to the first layer 62 and the second layer 64 provided on the molded portion 50, a method in which the optical element (a molded portion 50) on which the first layer 62 and the second layer 64 were provided are stored under a existence of high concentration of oxygen, a method in which O₂ plasma is treated, and a method in which ultraviolet light is irradiated to the optical element (a molded portion 50) on which the first layer 62 and the second layer 64 were provided under ambience of ozone. Herein the oxidation treatment according to the present invention is not limited to above method so long as increasing an oxidation degree of each SiO layer.

The first layer 62 and the second layer 64 are also oxidized by natural aging after forming the third layer 66 and the fourth layer 68. However, the oxidation treatment of the present invention means a treatment which is treated before installing in an apparatus such as an optical pickup apparatus and enhances an oxidation degree of SiO layer. In this process, an oxidation degree of SiO layer is changed purposefully by the oxidation treatment before forming the third layer 66 and the fourth layer 68.

The first layer 62 and the second layer 64 is basically the same composition. But in a process of forming each layer, because an inlet pressure (an inlet amount) of O₂ gas is different, there exists a surface boundary between these layers. This surface boundary can be observed by SEM (Scanning Electron Microscope) or TEM (Transmission Electron Microscope). From this observation result, the first layer 62 and the second layer 64 can be distinguished.

After that, the third layer 66 is formed on the second layer 62, and the fourth layer 68 is formed on the third layer 66, by vacuum evaporation.

By the treatment described above, the anti-reflection film 60 can be formed on surface 52 of molded portion 50, and thereby, the objective lens 37 can be produced.

Subsequently, a function of the optical pickup apparatus 30 will be described.

A blue laser light is emitted from the semiconductor laser oscillator 32 during recording the information into the optical disk D or during playback of the information recorded in the optical disk D. The emitted blue laser light is collimated to an infinite parallel light through the collimator 33, then is transmitted through the beam splitter 34 and the ¼ wave length plate 35. The blue laser light further forms a condensed light spot on an information recording surface D₂ through a protective substrate D₁ of the optical disc D after transmission through the aperture stop 36 and the objective lens 37.

The blue laser light after forming the condensed light spot is modulated by information bit at the information recording surface D₂ of the optical disc D and is reflected by the information recording surface D₂. The reflected light goes through the objective lens 37 and the aperture stop 36 in sequence, and its polarization direction is changed by the ¼ wave length plate 35, and it is reflected by the beam splitter 34. Astigmatism is given to the reflected light during going through the sensor lens group 38, accepted by the sensor 39 and converted to electric signal via photoelectric conversion by the sensor 39.

By repeating the operation as described above, the recording the information into the optical disk D or the playback of the information recorded in the optical disk D can be performed.

According to the above-described embodiment of the present invention, in the case of forming the anti-reflection film 60 of the objective lens, two SiO layers are formed as the first and second layer 62 and 64 respectively on the resin molded portion 50 and then these SiO layers are oxidized.

Therefore the light resistance can be improved as well as holding the adhesive property of the anti-reflection film 60 to the resin molded portion 50, the heat resistance and the light property of the anti-reflection film 60 by suppressing a cloud or a deformation of a resin mold portion 50 (refer to the following Examples).

### EXAMPLES

### Example 1

### (1) Preparation of Samples

As a resin, ZEONEX-350R (product of ZEON Corp.) was used and resin molded portion (a resin lens) was formed by injection-molding the resin thereof.

The resin lens had an effective diameter of 1 mm and a thickness at an axis of 1.57 mm and was used to an objective lens of an optical pickup apparatus exclusively for Blu-laser.

After that, layers described in Table 1 and 2 were formed and laminated to the resin molded portion by a vacuum deposition using an electron beam. In these layer forming processes, an inlet pressure of the oxygen gas and a thickness of each layer at SiO layer forming step were controlled in the condition indicated in Table 1 and 2.

After that, oxidation treatment was applied onto the resin molded portion having the multi-layers. As the oxidation treatment, the resin molded portion was stood 48 hours under an ambience at 60° C. and 80% R.H.

The resin molded portion treated with above treatment were referred to as “Samples 1 to 11” according to its layer constitution such as layer thickness or an inlet pressure of O₂ gas or with or without an oxidation treatment.

In Table 1 and 2, the lowest layer deposited in the item of “Layer Structure” is the first layer which formed directly onto the resin molded portion.

In Table 1 and 2, the first layer (SiO layer) in Samples 1 and 9 were formed by a vacuum deposition method using a resistance heating method.

In Table 1 and 2, “OA600” in Samples 1 and 9 were layers formed by vacuum evaporating using OA600 (manufactured by Optran) as the evaporation source and was a layer of (Ta₂O₅+5% TiO₂). In the case of forming layer of OA600, the layer was densified by forming with discharging by using a high frequency electric source.

### (2) Evaluation of Samples

(2.1) Evaluation of Adhesion Properties

In order to evaluate adhesion properties of the formed layer to the resin molded portion, a tape (No.859T produced by 3M) was allowed to adhere to each Sample and then peeled the tape vertically. After repeating these operations, adhesion properties of the formed layer to the resin molded portion was evaluated in view of numbers until a peel off of the layer was visually observed. Results are listed in Table 1 and 2. Adhesion properties were evaluated based on the following criteria.

A: Peeling of a layer was noted after 6 to 10 operations.

B: Peeling of a layer was noted after 2 to 5 operations.

C: Peeling of a layer was noted after 1 operation.

D: Peeling of a layer was noted during layer forming process.

(2.2) Heat Resistance

Each sample was left in the constant-temperature oven at 85° C. for 1 week, and then crack of the layer was observed by stereoscopic microscope (40 magnifications). Heat resistance of the layer was evaluated in tents of with or without of crack and its degree. The results of each sample were listed in Tables 1 and 2. In Tables, criteria A, B and C are based as follows:

A: No cracks were noted.

B: Cracks such as fine line were noted.

C: Large cracks were noted.

(2.3) Light Resistance

Each Sample was irradiated for 3 weeks with a blue laser light of 405 nm at a temperature of 85° C., with a power of 100 mW. The value of spherical aberration between before and after the irradiation of laser was measured by using surface interferometer and the amount of variation value was calculated. Light resistance was evaluated from these calculated results. The results of each sample were listed in Tables 1 and 2. In Tables 1 and 2, criteria A, B, C and D are based as follows.

A: The amount of variation in spherical aberration is less than ±10 mλ.

B: The amount of variation in spherical aberration is ±10 mλ or more and less than ±20 mλ.

C: The amount of variation in spherical aberration is ±20 mλ or more and less than ±50 mλ.

D: The amount of variation in spherical aberration is more than ±50 mλ.

TABLE 1

| | Sample | | | | |
|---|---|---|---|---|---|
| | 1 | 2 | 3 | 4 | 5 |
| | Comp. | Comp. | Comp. | Comp. | Comp. |
| | Air side | | | | |
| Layer | SiO₂ | SiO₂ | SiO₂ | SiO₂ | SiO₂ |
| Structure | OA600 | (103 nm) | (102 nm) | (400 nm, | (400 nm, |
| | SiO₂ | ZrO₂ | ZrO₂ | 2.5 × 10⁻² | 1.5 × 10⁻² Pa) |
| | OS600 | (25 nm) | (25 nm) | Pa) | |
| | SiO₂ | SiO₂ | SiO₂ | | |
| | SiO | (15 nm) | (400 nm) | | |
| | Molded resin side | | | | |
| Oxidation | None | Done | Done | Done | Done |
| Adhesion | B | C | D | A | C |
| Heat | B | A | C | C | A |
| resistance | | | | | |
| *1 | D | C | B | B | B |

*1: Variation of spherical aberration
*2: Comp.: Comparative example

TABLE 2

| | Sample | | | | | |
|---|---|---|---|---|---|---|
| | 6 | 7 | 8 | 9 | 10 | 11 |
| | Comp. | Comp. | Inv. | Inv. | Inv. | Inv. |
| | Air side | | | | | |
| Layer | SiO | SiO₂ | SiO | SiO₂ | SiO₂ | SiO₂ (110 nm) |
| Structure | (380 nm, | (102 nm) | (380 nm, | OA600 | (102 nm) | ZrO₂ (26 nm) |
| | 1.5 × 10⁻² Pa) | ZrO₂ | 1.5 × 10⁻² Pa) | SiO₂ | ZrO₂ | SiO₂ (48 nm) |
| | | (25 nm) | | OS600 | (25 nm) | ZrO₂ (29 nm) |
| | SiO | SiO₂ | SiO | SiO₂ | SiO₂ | SiO₂ |
| | (20 nm, | (200 nm, | (20 nm, | | (200 nm, | (400 nm, |
| | 2.5 × 10⁻² Pa) | 1.5 × 10⁻² Pa) | 2.5 × 10⁻² Pa) | | 1.5 × 10⁻² Pa) | 1.5 × 10⁻² Pa) |
| | | SiO | | SiO | SiO | SiO |
| | | (10 nm, | | | (10 nm, | (10 nm, |
| | | 2.5 × 10⁻² Pa) | | | 2.5 × 10⁻² Pa) | 2.5 × 10⁻² Pa) |
| | Molded resin side | | | | | |
| Oxidation | None | Done | Done | Done | Done | Done |
| Adhesion | B | A | A | A | A | A |
| Heat | A | A | A | A | A | A |
| resistance | | | | | | |
| *1 | C | B | A | B | A | A |

*1: Variation of spherical aberration
*2: Comp.: Comparative example,
Inv.: Inventive Example

### (3) Conclusion

As shown Table 1 and 2, Samples 8 to 11 has excellent result in all of adhesion property, heat resistance and light resistance comparing to Samples 1 to 7.

Especially, from the comparison between Sample 1 and 9 or the comparison between Sample 6 and 8, which is different by “Done” or “None” of oxidation treatment, oxidation treatment results in improving light resistance extremely in addition to adhesion property and heat resistance.

As can clearly seen from above result, to form two SiO layers onto the resin molded portion and to oxidize those SiO layers is effective to keep improved adhesion property and heat resistance and further to increase light resistance.

What is claimed is:

1. A production method of an optical element, which is utilized in a pickup apparatus using a light source emitting light having a wavelength of 380 nm to 420 nm and has a functional layer formed on a molded portion comprising a resin having an alicyclic structure, comprising steps of
forming a first SiO layer on the molded portion by a vapor deposition process using SiO as an evaporation source and introducing O₂ gas under a predetermined pressure,
forming a second SiO layer on the first SiO layer by a vapor deposition process using SiO as an evaporation source and introducing O₂ gas under a pressure lower than the pressure used in forming the first SiO layer, and
oxidizing the first SiO layer and the second SiO layer.

2. The production method of the optical element of claim 1, wherein
in the step of forming the first SiO layer, the pressure of the introduced O₂ gas is adjusted to be in the range of 1.5×10⁻² to 2.5×10⁻² Pa to make a refractive index of the first SiO layer in the range of 1.47 to 1.53, and a thickness of the first SiO layer is adjusted to be in the range of 10 to 50 nm; and
in the step of forming the second SiO layer, the pressure of the introduced O₂ gas is adjusted to be in the range of 5.0×10⁻³ to 1.5×10⁻² Pa to make a refractive index of the second SiO layer in the range of 1.53 to 1.83, and a thickness of the second SiO layer is adjusted to be in the range of 190 to 5000 nm.

3. The production method of the optical element of claim 1, wherein the step of oxidizing the first SiO layer and the second SiO layer comprises at least one of the following steps:
holding the molded portion having the first SiO layer and the second SiO layer for 10 hours to 7 days under an ambience of temperature lower than 90° C. and of lower than 90% relative humidity;
subjecting the first SiO layer and the second SiO layer to an ion implanting process;
immersing the molded portion having the first SiO layer and the second SiO layer into water,
subjecting the first SiO layer and the second SiO layer to an oxygen plasma treating and
subjecting the first SiO layer and the second SiO layer to a radiation of ultraviolet light under an ambience of ozone.

4. The production method of the optical element of claim 1, further comprising steps of:
forming a third layer on the second SiO layer with a high refractive index material having a refractive index 1.61 or more, and
forming a fourth layer on the third layer with a low refractive index material having a refractive index less than 1.61.

5. The production method of the optical element of claim 4, comprising a step of forming a fifth layer or more by repeating alternately laminating the layer formed with the high refractive index material and the layer formed with the low refractive index material.

6. An optical element produced by the production method of claim 1.
